(19) United States
(12) Patent Application Publication
(10) Pub. No.: US 2014/0156102 A1
(43) Pub. Date: Jun. 5, 2014

(54) DEVICE FOR THE HYBRID HEATING OF A FLUID OF A TANK

(71) Applicant: POOLSTAR, Le Rove (FR)

(72) Inventors: Raphael ELBAZ, Marseille (FR); Georges AMSELLEM, Vitrolles (FR)

(73) Assignee: POOLSTAR, Le Rove (FR)

(21) Appl. No.: 14/075,821

(22) Filed: Nov. 8, 2013

Related U.S. Application Data
(60) Provisional application No. 61/724,117, filed on Nov. 8, 2012.

(51) Int. Cl. F24H 9/20; F24H 4/04; G05D 23/19; F24H 1/18

(52) U.S. Cl. CPC F24H 9/2021; F24H 1/185; F24H 4/04; G05D 23/19
USPC 700/300; 392/307; 219/494

(57) ABSTRACT

The invention relates to a system comprising a hybrid heating device (PAC-H) for a fluid contained in a remote tank (SP), comprising a fluid inlet (Wi) for receiving the fluid from the tank, first and second internal heating means for said fluid, control means co-operating with said first and second internal heating means, and a fluid outlet (Wo) for returning said heated fluid. Said control means activate alternately or simultaneously the first and second internal heating means according to a setpoint and/or a predetermined operating parameter of the hybrid heating device.

The invention relates to a heating device for a fluid of a swimming pool or more generally of a tank. Depending on the installation location of a tank, its usage period may be decreased to several weeks per year. Heating water for a swimming pool is thus an excellent solution to take advantage of it all year long. Resorting to a device for heating water of one's swimming pool is also of interest even when it is installed in a region that enjoys a favorable climate. In fact, a heating device enables one to deal with any unstable weather: rain, wind, hail, snow, and so on. It is thus not necessary to wait for shining sun to appear at a given location and heat up the water of one's tank free of charge. Consequently, providing a heating device considerably increases the usage period of a tank.

There are different heating devices for tanks: they may be heating devices incorporated or submerged in a tank or vat of which one wishes to heat the contents, or fluid heating devices of a remote tank, in other words—in contrast to the preceding ones—co-operating with said tank by means of ducts or conduits, [with] the heating device remaining at a distance of said tank. According to this second category, we can also primarily mention electric exchangers or heaters, devices that make use of solar energy or also heat pumps. There are also other, more complex and expensive devices that operate for example using fuel or gas, devices associated with specific exchangers to outfit public and very high-capacity swimming pools.

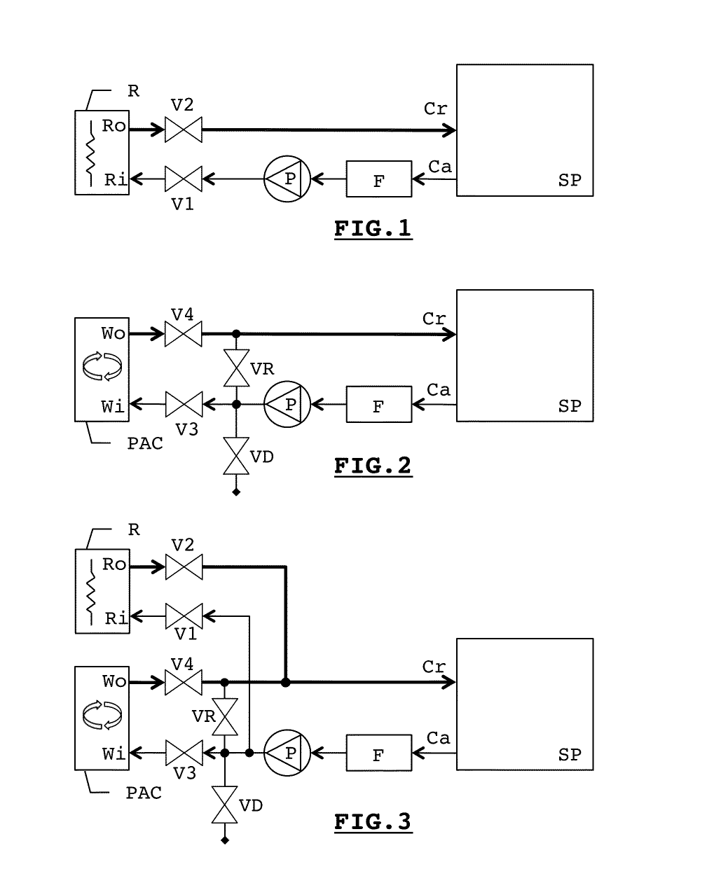

Electric heaters have numerous advantages. The electric energy used is easily accessible and remains available all year long. These devices thus enable one to decrease one's dependence on weather conditions. In addition, they are generally very simple to install and require minimum upkeep. Their generally reduced size and their moderate purchase cost constitute their major advantages. FIG. 1 schematically describes a system according to which a swimming pool SP co-operates with an electric heater R. The water from swimming pool SP is drawn via an intake conduit Ca by the action of a pump P creating a sufficient flow to temper the water of the swimming pool. The cold water may be filtered by a filtration system F generally provided upstream from pump P. Intake conduit Ca carries cold water to electric heater R. Within said electric heater, the water circulates in contact with an electrical resistance from fluid inlet Ri to a fluid outlet Ro. The water is heated by said resistance when the latter receives electrical power. Lastly, the heated water is directed (still under the action of pump P) to the swimming pool by a delivery conduit Cr. In FIG. 1, the intake conduit Ca and delivery conduit Cr are respectively depicted by thin and thick lines. An electric heater generally has a setpoint and/or programming housing to activate the electrical resistance. To possibly isolate heating device R, two valves V1 and V2 may be respectively positioned upstream and downstream of electric heater R—in terms of the intake and delivery conduits. These valves are generally intended to be operated by a user of the swimming pool or by a maintenance technician to perform maintenance operations on electric heater R.

However, resorting to this type of equipment gives rise to disadvantages. First, we can mention the very high cost of electric energy consumed given the low energy output of an electric heater: at the very most, 1 kW is supplied for 1 kW consumed. Such a heating device also requires an electric infrastructure sufficient to meet intense and regular usage (triple-phase system, electric meter of fifty amperes minimum, etc.). Given the high energy costs, such a device is generally used to temper the water of small tanks over short usage periods.

Certain swimming pool owners are thus won over by alternative solutions. There are for example solar heating devices. Solar energy—known as renewable energy—used by this type of equipment is free. Such a heating device (comprising one or several solar panels) is relatively efficient for small tanks and in high season. Its acquisition cost is also relatively modest. However, the output of such equipment is very low, whereas its size is imposing, even ill-proportioned. It becomes quasi ineffective to regulate the water temperature of a substantially sized swimming pool.

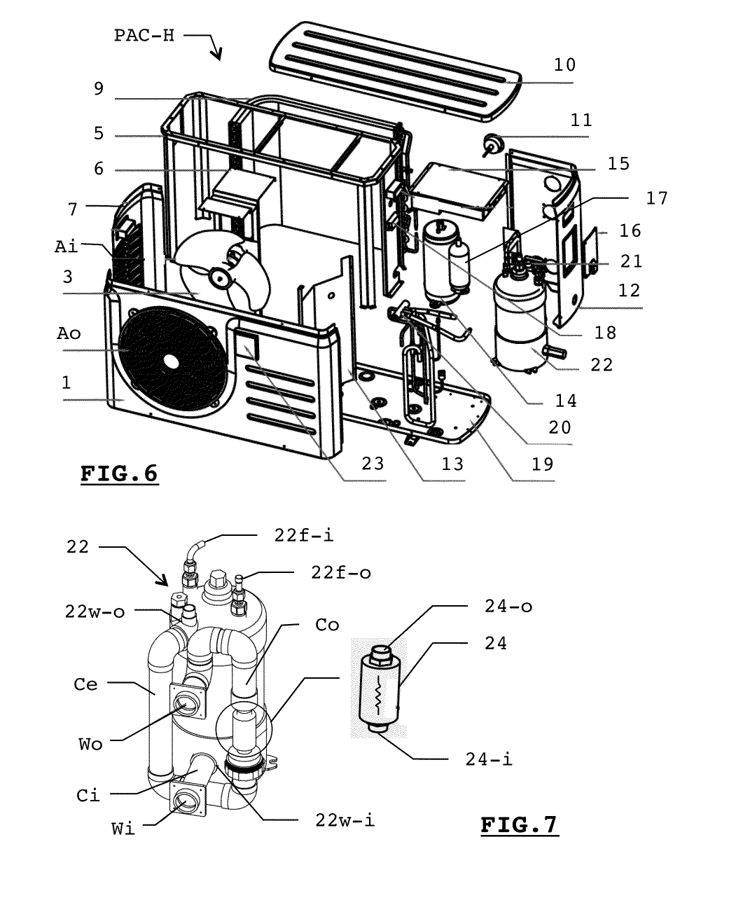

To mitigate the disadvantages and limitations of electric or solar heaters, swimming pool owners have increasing recourse to heat pumps, hereinafter referred to as HPs. Such a heating device operates with electricity just like a conventional electric exchanger. An HP is based on a simple principle: it recovers the calories present in the ambient air, transforms them into heat, and transfers this heat to the fluid that one wishes to heat. In contrast to a conventional electric exchanger (such as electric exchanger R described in relation to FIG. 1), the output of an HP is high: an HP produces between 2 and 5 times more energy than it consumes. Besides low electrical consumption, an HP offers tremendous ease in regard to programming, making its use easy and particularly suitable. One can also qualify an HP-type solution as “green” since the principle source of energy comes from the calories captured free of charge in the ambient air. FIG. 2 schematically describes a system enabling one to heat water for a tank SP by means of an HP hereafter referred to as PAC. As for the system described in FIG. 1, cold water of tank SP is drawn by the action of a pump P. The water may be filtered by filtration means F. It is carried to an HP via an intake conduit Ca represented in FIG. 2 by a thin line. The HP referred to as PAC comprises a water inlet Wi. The water is then heated by an exchanger inside the HP and leaves by a fluid outlet Wo. The principle of operation of an HP will be detailed in conjunction with FIG. 6 further on. The heated water is then carried to tank SP by a delivery conduit Cr, under the action of pump P. Conduit Cr is represented by a thick line in FIG. 2. Such a system may advantageously comprise two valves V3 and V4 positioned respectively upstream and downstream of the HP to enable maintenance operations on said HP. In addition, to protect the exchanger of the HP, it may be wise to provide a regulating valve VR positioned in parallel with the HP between the intake conduit Ca and delivery conduit Cr. This valve VR allows one to regulate the flow of water circulating in said HP referred to as PAC. The more valve VR is open, the lower the flow of cold water supplying the HP. Lastly and particularly for performing wintering operations (see further on), a relief valve VD may also be provided upstream from the HP. It allows—when actuated (or open)—one to empty the exchanger of the HP referred to as PAC.

Even though it is very appealing, an HP does have its limitations however. It becomes generally quasi-inoperable as soon as the temperature of the ambient air drops below 2° C. An HP is thus not efficient during winter periods. In addition, an HP allows one to increase the temperature of a tank in the order of 1° C. to 2° C. per day. Thus, after a hail storm for example, or after a very windy period, the temperature of a tank may decrease suddenly by several degrees. It may thus be necessary to sometimes wait several days before regaining a swimming temperature suited to one's expectations. Of all the solutions mentioned, an HP does offer the best output. However, its acquisition cost and maintenance cost are higher.

Regardless of the technology of the heating device chosen, it generally does not by itself satisfy the tank owners: either because of excessive energy costs, or because of an excessively low output. Certain swimming pool owners are thus forced to install several independent and complementary devices to increase the usage period of their swimming pools: for example, an HP used during the summer to take advantage of renewable and inexpensive energy and a second device in the form of an electric heater for using the tank during the winter when the ambient temperature may be below 5° C. Such a system is described in conjunction with FIG. 3. A swimming pool SP co-operates with an HP and an electric heater R. The cold water is drawn from said swimming pool via an intake conduit Ca by the action of pump P. This water may be filtered by filtration means F. As for the system described in conjunction with FIG. 1, pump P carries via a intake conduit Ca cold water to an electric heater R. It may be isolated—if necessary—from the system by means of two valves V1 and V2 situated respectively upstream and downstream of said heater R. In parallel with said electric heater, pump P, via conduit Ca, also supplies cold water to an HP referred to as PAC in a manner similar to the system described in conjunction with FIG. 2. The HP may also be isolated from the system by two valves V3 and V4 situated respectively upstream and downstream from the HP. The flow of the fluid carried by line Ca to fluid inlet Wi of the HP may be regulated by means of a regulating valve VR positioned in parallel with the HP, between fluid inlet Wi and fluid outlet Wo of said HP. As mentioned in conjunction with FIG. 2, a relief valve VD may be advantageously provided to empty the exchanger of the HP. The water heated by the HP is carried from fluid outlet Wo—possibly via valve V4—to swimming pool SP by a delivery conduit Cr under the action of pump P. Similarly, the water heated by electric heater R is carried from fluid outlet Ro of said heater—possibly via valve V2—by said conduit Cr represented by a thick line on FIG. 3. Fluid outlets Wo and Ro are thus joined at delivery conduit Cr. Such a system requires a large number of valves. It is up to the swimming pool user to actuate said valves and to advisedly program heating devices HP and R. These manipulations maximize the risk of errors, malfunctioning of the system, and do not optimize the output of such a mixed system. The maintenance of the latter is not very intuitive. Having people separately manage the different heating devices generally proves to be expensive in terms of its operation and energy output. In addition, the acquisition and upkeep of equipment by the manufacturers, who sometimes differ, may be dissuasive. Lastly, the installation of the entire unit may be complex due to the interactions between the pieces of equipment, which may have little compatibility amongst each other.

The invention consists of designing a heating device for swimming pools or tanks that does away with most of the disadvantages of known systems, while offering numerous advantages. Accordingly, the invention provides a heating device that one can qualify as a hybrid fitted—according to a preferred embodiment—with a heat pump to be combined with an electric exchanger. More than a simple juxtaposition of two known devices, a hybrid device according to the invention creates great synergy between the two heating modes, optimizing the output of the entire unit, increasing its efficiency, simplifying its installation and maintenance, and offering a particularly optimized size.

Among the many advantages obtained from a device according to the invention, one can mention in a non-exhaustive manner that it allows one to:
Regulate the temperature of the water of a swimming pool or a tank throughout the entire year, thereby not having to be dependent on the seasons, the climate, or occasionally capricious weather;
Accelerate the heating of water for a tank (roughly by a factor of two) with regard to the action of a conventional HP;
Utilize an electric system that is non-dedicated or even slightly modified;
Have a large choice in the configuration and/or programming that is easily modifiable to meet the needs of the user and specifications of the tanks or the system: different operating modes are offered to users for utilizing the different internal heating means, alternatively or in combination;
Offer a heating device that is simple to install and use, similar to that of an HP, with increased efficiency, be it during periods appropriate for using a swimming pool (summer, spring, fall) or even during winter, as when heating a swimming pool by means of an electric heater;
Avoid tedious or complex manipulations for a user of a tank, and consequently avoid any risk of improper use, malfunction, or deterioration of the system;
Offer a particularly competitive acquisition cost (estimated at 15 to 20% greater than the acquisition cost of a conventional HP) thanks to a particularly innovative design;
Possibly offer remote programming and/or actuation via a panel or more generally a remote setpoint interface that co-operates with the control means of the device (wired or wireless communication): emergency stop, manual mode, automatic mode, temperature adjustment, accelerated or nominal heating, and so on.

To this end, the invention relates to a hybrid heating device of a fluid contained in a remote tank comprising a fluid inlet to receive the fluid of the tank, a first internal heating means of said fluid, control means that function with said first internal heating means, and a fluid outlet to return said heated fluid. To optimize the output of the device and facilitate operation of a system comprising such a device, the latter also comprises a second internal heating means, said control means being suited to also function with said second internal heating means and for activating alternately or simultaneously the first and second internal heating means according to a setpoint and/or a predetermined operating parameter of the device.

To limit the size and facilitate maintenance of such a hybrid heating device, the latter advantageously comprises a housing incorporating the first and second internal heating means as well as the control means.

According to a preferred embodiment, the first internal heating means is advantageously an air-water heat pump, whose compressor co-operates with the control means. In the same manner, the second internal heating means may be an electric exchanger.

To implement simultaneously or alternately said heating means that are internal to the hybrid heating device, said internal means may be advantageously arranged “in series.” Thus, according to such an arrangement, the fluid inlet of the hybrid device supplies fluid to the first internal heating means, which in turn supplies the second internal heating means, which co-operates with the fluid outlet.

In order that the control means can trigger an internal heating means, the first and second internal means may co-operate with the control means by means of a control bus.

To allow a user to determine a temperature of the fluid of the tank as a setpoint, a hybrid heating device according to the invention may comprise or communicate with a setpoint interface, said setpoint interface co-operating with the control means of the device.

A hybrid heating device according to the invention may incorporate, in the generation of a command for triggering an internal heating means, data associated with its functioning or its environment. To do so, such a device may comprise measurement or safety means co-operating with control means, the latter being suited to activate alternately or simultaneously the first and second internal heating means according to information supplied by said measurement or safety means in addition to the setpoint and/or predetermined operating parameter of the device.

To regulate the temperature of the fluid heated by a hybrid heating device according to the invention, said measurement or safety means may comprise a sensor to measure the temperature of the fluid received at the fluid inlet. They may also comprise a sensor to measure the temperature of the ambient air so that the control means may trigger the internal heating means having the best output according to the ambient temperature.

According to a first particularly advantageous embodiment, the control means of a hybrid heating device according to the invention comprises a processing unit comprising—or co-operating with—memory means recording the predetermined operating parameter of the device and/or a computer program consisting of one or more program instructions, whose respective interpretations or executions by the processing unit triggers the implementation of a process for generating the command to activate the first and/or second internal heating means.

As a variant, the control means of a hybrid heating device according to the invention may comprise a combinatorial logic circuit translating a wired logic implementing a process for generating a command to activate the first and/or second internal heating means. To be able to record the predetermined operating parameter of the device, such control means may comprise or co-operate with the memory means.

According to a second aspect, the invention provides for a command-generating process for activating an internal heating means of a hybrid heating device according to the invention. Such a procedure being implemented by the control means of said hybrid heating device comprises one or several iterations comprising respectively a stage for reading a set-point and/or predetermined operating parameter and a stage for controlling the activation of an internal heating means according to said set-point and/or said parameter.

To implement a first operating mode of the device, the stage for controlling activation of said internal heating means may comprise a stage for reading the value of the temperature of the fluid received by the fluid inlet, a stage for comparing said temperature measured at the setpoint, [and] a stage for triggering the first heating means if said measured temperature is less than said setpoint.

This operating mode may also be enhanced so that a hybrid device conforming to the invention may favor an internal heating means having the best output according to the temperature of the ambient air. To do so, such a device advantageously comprises a sensor to measure the air temperature. In addition, the predetermined operating parameter of said device advantageously comprises a predetermined value of the ambient air temperature below which the output of the first heating means is insufficient. According to this enhancement, the stage of a the process conforming to the invention for controlling the activation of an internal heating means may comprise a prior stage for reading the measurement value of the ambient air temperature. The stage for triggering the first heating means is not executed unless said measured value of the ambient air temperature is greater than said predetermined value. If not, the stage for controlling the activation of an internal heating means comprises a stage for actuating the second heating means.

To implement a second operating mode taking into account the temperature trend of the fluid in the tank, the stage for controlling activation of an internal heating means of a process according to the invention may comprise a stage for recording the value of the measured temperature of the fluid received at the fluid inlet in the memory means of the hybrid heating device. To specify the rate of the iterations of a process according to the invention, the predetermined operating parameter of the device may advantageously comprise an iteration frequency, said process comprising a plurality of iterations triggered respectively according to said frequency.

To implement a third particularly advantageous operating mode allowing one to quickly regain a fluid temperature close to the setpoint after its sudden drop (following a hail or high-wind phenomenon for example), the predetermined operating parameter may advantageously comprise a set value for a sudden temperature decrease. The stage for controlling the activation of an internal heating means of a process according to the invention may then simultaneously activate the first and second internal heating means if the value of the measured temperature of the fluid received by the fluid inlet is less than that recorded during a preceding iteration reduced by said determined value for a sudden temperature decrease.

To implement a fourth particularly advantageous operating mode during the cold seasons, when the first internal heating means consists of an air-water heat pump whose exchanger is particularly sensitive to freezing, the predetermined operating parameter may advantageously comprise a predetermined value of the temperature of the tank fluid below which the integrity of the first heating means is jeopardized. The stage for controlling the activation of an internal heating means of a process according to the invention may trigger the second internal heating means as soon as the temperature of the fluid received by the fluid inlet is roughly equal to said predetermined value.

According to a third aspect, the invention relates to a computer program comprising one or several program instructions that can be respectively interpreted or executed by the processing unit of a hybrid heating device (when the control means of the latter consists of such a processing unit functioning with memory means), and whose interpretation or execution by said unit triggers the implementation of a command generation process according to the invention.

According to a fourth aspect, the invention relates to a system comprising a tank containing a fluid to be heated, a remote heating device functioning with said tank by means of an intake conduit for drawing fluid from the tank and carrying said fluid to the fluid inlet of the heating device and a delivery conduit for carrying said heated fluid from a fluid outlet of the heating device toward the tank. Such a system also comprises a pump, whose action creates a flow of said fluid within the intake and delivery conduits. To increase the output and performance in terms of heating the fluid of the tank, the heating device of such a system is a hybrid heating device according to the invention.

Such a system may advantageously comprise a hybrid heating device whose control means consist of a processing unit co-operating with memory means, said processing unit implementing a process for the first and/or second internal heating means generating commands to said hybrid heating device according to a process according to the invention.

Other features and advantages will emerge more clearly in reading the description that follows and examining the drawings that accompany it among which:

FIG. 1 (already described) schematically represents a system comprising an electric heater;

FIG. 2 (already described) schematically represents a system comprising a heat pump (HP);

FIG. 3 (already described) schematically represents a system comprising two separate heating devices and arranged respectively in parallel to each other: a heat pump (HP) and an electric heater;

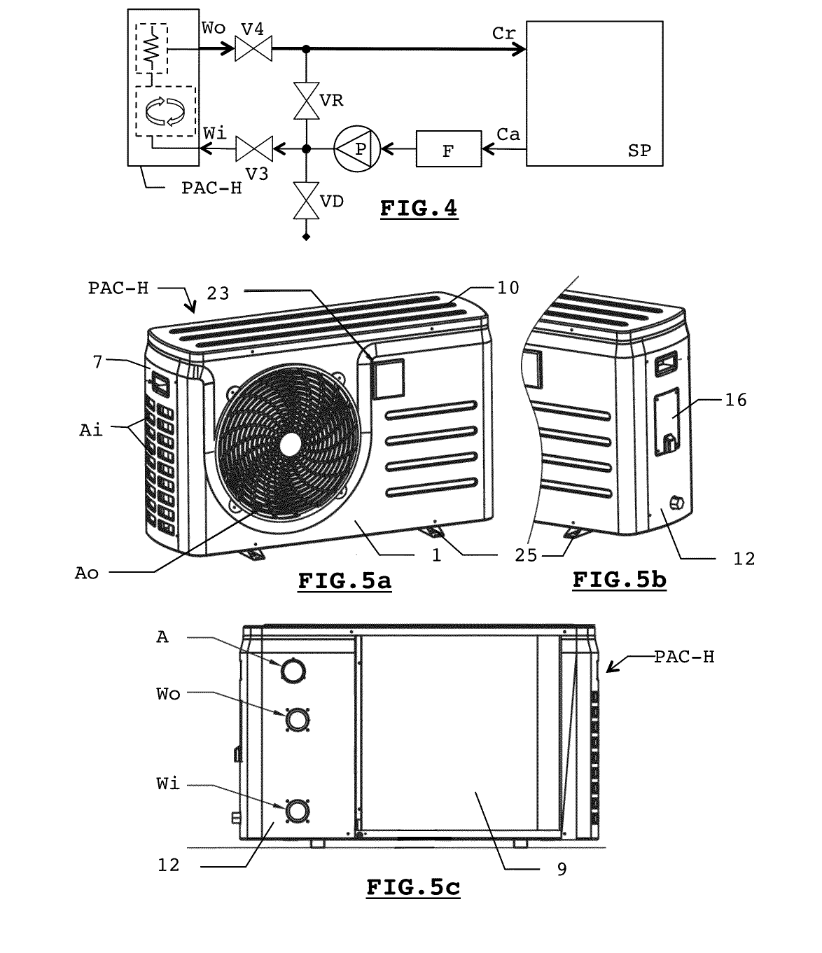

FIG. 4 schematically represents a system comprising a hybrid heating device according to the invention;

FIGS. 5A, 5B and 5C depict different external views of a hybrid heating device according to the invention;

FIG. 6 depicts an exploded view of a hybrid heating device according to the invention;

FIG. 7 is a detailed representation of an exchanger of a heat pump coupled to an electrical resistance incorporated in a hybrid heating device according to the invention.

To mitigate the disadvantages caused by known solutions, a device according to the invention comprises two different internal means for heating a fluid of a remote tank. Such a hybrid device makes use respectively and preferentially of hydrothermal energies (of the heat pump-type) and electrical (of the electrical resistance-type). Such a hybrid device also comprises control means for managing the two internal heating means in order to optimize the functioning of the entire unit. Such a hybrid heating device is most advantageously arranged for constituting a compact unit (the elements being incorporated within a same housing) offering twice the energy output without doubling the electrical consumption necessary for its functioning. A system comprising such equipment is described in conjunction with FIG. 4. Such a system is similar to that described previously in conjunction with FIG. 2. According to one particularly advantageous embodiment, such a hybrid heating device PAC-H regulates the water temperature of a remote swimming pool SP. This device PAC-H comprises two complementary and internal heating means or sources: an air-water HP and an electrical resistance, serving as a non-limiting example. Hybrid heating device PAC-H comprises a fluid inlet Wi and a fluid outlet Wo from which the heated water leaves—in this case, water from swimming pool SP. The cold water from said swimming pool is drawn by the action of a pump P and carried to fluid inlet Wi of the hybrid heating device by an intake conduit Ca, a conduit represented by a thin line in FIG. 4. To possibly regulate the flow of cold water circulating in heating device PAC-H, a regulating valve VR may advantageously be positioned in parallel with device PAC-H between intake conduit Ca and a delivery conduit Cr carrying heated water from fluid outlet Wo to swimming pool SP. This delivery conduit Cr is represented by a thick line in FIG. 4. To purify the cold water of the swimming pool upstream from hybrid heating device PAC-H, the system may advantageously comprise filtration means F preferentially positioned upstream from pump P. As for the system described in conjunction with FIG. 2, the system described in FIG. 4 may comprise a relief valve VD for emptying the exchanger of device PAC-H, even though as will be seen later, a hybrid heating device according to the invention may certainly and automatically implement an operating mode preventing any risk of degrading the exchanger of the internal HP of the device. The invention thus allows one to do away with a manual and tedious winterization process consisting of purging intake conduits Ca and delivery conduits Cr, and particularly, the exchanger of device PAC-H. Valve VD may thus be omitted if device PAC-H comprises such programming. As for the systems described in conjunction with FIG. 1 or 2, hybrid heating device PAC-H may be isolated from intake conduits Ca and delivery conduits Cr by means of two valves V3 and V4 positioned respectively upstream and downstream of device PAC-H. One notes that the system is similar to that of a conventional HP. It minimizes the amount of equipment needed and the manual operations required by a user of a tank equipped with a hybrid heating device. One also obtains a very simple and inexpensive system comprising only one single hybrid heating device, whose output greatly exceeds that of the system described in conjunction with FIG. 3.

A heating device PAC-H according to the invention is extremely compact as evidenced by FIGS. 5a to 5c. According to a preferred embodiment, such a device comprises an air-water HP and an electrical exchanger (or resistance) arranged to mutually co-operate. A hybrid heating device comprises a housing or casing whose exterior face (FIG. 5a), sides (FIG. 5b), and back (FIG. 5c) are roughly similar to those of a conventional air-water HP. In FIG. 5a, one can clearly discern an exterior housing comprising a left side panel comprising openings constituting lateral air inlets Ai. A front panel 1 comprises a roughly circular opening constituting a primary air outlet Ao. The latter is advantageously arranged in the form of a grating (or comprises such a grating) protecting an internal fan (not described in FIG. 5a) favoring the circulation of air taken in via inlets Ai, passing through evaporator 9 (whose back appears in FIG. 5c, which describes a rear view of a device PAC-H) and discharged via outlet Ao. Advantageously, front panel 1 of device PAC-H comprises a setpoint and/or output interface 23 allowing a user to parameterize the device and/or read the information associated with the functioning of said device. Such an interface 23 may advantageously comprise a screen, possibly a touch-screen, and/or a keyboard. The interface may as a variant be positioned on a side panel. Device PAC-H may comprise feet provided under its lower face for seating the heating device on the ground or on any support provided for this purpose. An upper panel 10 covers device PAC-H. FIG. 5b depicts an opposing side view opposite to that describing air inlets Ai. Said FIG. 5b depicts a side and rear panel 12 comprising an electrical connection terminal 16 preferably equipped with a protective cover. It is by means of this terminal 16 that device PAC-H may be supplied with electrical power. It also allows one to possibly connect third-party devices, such as additional pumps that are slaved to said device PAC-H.

FIG. 5c describes a rear view of a hybrid heating device PAC-H. One can see rear side panel 12 possibly comprising an air vent A (opening arranged in said panel 12) allowing for simple or assisted ventilation of internal elements of the device. FIG. 5c also describes two openings applied in said panel 12 provided for fluid inlet Wi and fluid outlet Wo of device PAC-H. Said fluid inlet and/or outlet could also be arranged on the front panel on one of the side walls of device PAC-H.

According to a preferred embodiment, a hybrid heating device according to the invention comprises a heat pump and an electric heater. FIG. 6 depicts an exploded view of such a hybrid device PAC-H. Like any conventional heat pump, device PAC-H comprises essentially an evaporator 9 which draws calories from the ambient air to heat a refrigerant and to vaporize it under the effect of a temperature increase. Evaporator 9 is thus in contact with the ambient air (according to the views of device PAC-H described in conjunction with FIGS. 5a and 5c). Through the action of a fan 3, the air enters (via inlets Ai in particular) device PAC-H, co-operates with evaporator 9 (which recovers the calories from the air and transmits them to the refrigerant), and is then discharged via outlet Ao. A compressor 14 draws in the refrigerant and compresses it under high pressure to increase its temperature. A manometer 11 is provided to indicate the pressure of the refrigerant. According to the ambient temperature and atmospheric pressure, the pressure of said fluid may generally vary from 250 to 400 psi. When compressor 14 is idle, the pressure measured by said manometer 11 is generally between 150 and 350 psi. After a long period of non-utilization, the pressure may decrease below 100 psi. If the pressure decreases further (for example, if it goes down to roughly 80 psi), this may mean a leak in the internal circuit of the refrigerant.

Device PAC-H also has an exchanger 22 that is functionally similar to an electric heater. It is constituted of a tube through which the fluid passes (for example, swimming pool water that one wishes to heat) in contact not with an electric resistance but a second tube inside the exchanger, occasionally in the shape of a coil or any other configuration, within which the pressurized, thus very hot, refrigerant transits. Inside exchanger 22, the heat of the refrigerant is transferred to the fluid circulating in exchanger 22 (in other words, the swimming pool water). The refrigerant circulates from there into a pressure regulator 17 that decreases the pressure and initiates vaporization to begin a new cycle. The refrigerant thus circulates in a closed circuit within device PAC-H: from evaporator 9, to compressor 14, into exchanger 22, to pressure regulator 17, and then back to evaporator 9. The co-operation between the compressor, exchanger, and pressure regulator 17 is advantageously executed by a four-way valve 20. For example, swimming pool water that one wishes to heat is received by fluid inlet Wi. It passes through exchanger 22, of which a detailed view is depicted in FIG. 7, and is then emitted by fluid outlet Wo of the hybrid heating device. In FIG. 7, one can see refrigerant inlets 22f-i and outlets 22f-o. One can also see a first internal conduit Ci carrying the cold fluid (for example water from a tank or a swimming pool) from inlet Wi to fluid inlet 22w-i of exchanger 22. In the same way, FIG. 7 describes a second internal conduit Co of device PAC-H co-operating with fluid outlet Wo for carrying the fluid heated by hybrid heating device PAC-H. Contrary to a conventional HP, said second internal conduit Co does not co-operate directly with fluid outlet 22w-o of exchanger 22. A hybrid device PAC-H according to the invention comprises downstream of exchanger 22 and upstream of fluid outlet Wo an electric exchanger 24 comprising an electric resistance. When said resistance is supplied with electric power, the fluid circulating within said electric exchanger 24 is heated through the contact with said resistance. It thus circulates from fluid inlet 24-i toward fluid outlet 24-o. According to an embodiment of device PAC-H depicted in FIG. 7, exchanger 24 is inserted between fluid outlets 22w-o of exchanger 22 and fluid outlet Wo of the PAC-H. A third internal conduit Ce thus connects fluid outlet 22w-o of exchanger 22 to inlet 24-i of electric exchanger 24. Fluid outlet 24-o of the latter is connected to the second internal conduit Co, whose distal part co-operates with fluid outlet Wo. Electric exchanger 24 is sized to stand in for or complete the nominal functioning of the HP inside device PAC-H. It is thus generally less energy-consuming than a conventional electrical heater sized to heat a tank by itself, such as described in conjunction with FIG. 1. The first and second internal heating means (respectively, the air-water HP incorporating compressor 14 and electric exchanger 24) of hybrid device PAC-H thus co-operate in series, the first means being supplied with fluid to be heated by fluid inlet Wi, supplying in turn—by an internal conduit—the second internal heating means in turn co-operating with fluid outlet Wo.

FIG. 6 also describes the advantageous use of a frame 5 arranged for supporting front panels 1, side panels 7 and 12, evaporator 9, and a lower panel 19 on which rest (attached by any means) in particular compressor 14 and exchanger 22. These latter items may be isolated from the space, within which is created the air circulation by the action of fan 3 (supported by a support 6 co-operating with frame 5), by a vertical and optional partition 13.

In conjunction with FIG. 6, hybrid heating device PAC-H also comprises control means 15 whose function consists of controlling (or triggering) jointly or alternately the two energy sources or internal heating means (compressor and electric exchanger). Said control means 15 function with electric actuators of device PAC-H (primarily compressors 14, fan 3, and electric exchanger 24) and generate one or more commands for initiating the implementation of the first (compressor 14) and/or second (electric exchanger 24) internal heating means of said device PAC-H. The commands are advantageously transmitted by control means 15 to internal heating means by a control bus not depicted in FIG. 6.

The control means 15 also co-operate advantageously with the measurement means of the functioning of hybrid heating device PAC-H, such as one or more measurement sensors or manometer 11 described previously. For example, a flow sensor 21 may also be advantageously provided upstream from exchanger 22. In fact, the latter constitutes one of the most fragile and expensive components of device PAC-H. When the refrigerant outputs a great amount of heat, exchanger could be irreparably damaged in the absence of fluid (for example, water from a distant tank) circulating inside of it from inlet 22w-i. To this end, it is essential that a minimum flow of fluid to be heated passes through said exchanger 22. The flow measurement or the simple detection of a fluid circulating from inlet 22w-i toward outlet 22w-o of exchanger 22 may thus be acquired by sensor 21. This measurement or detection is advantageously transmitted to control means 15 by a signal bus not depicted in FIG. 6. The absence or lack of flow detected within exchanger 22 may therefore be interpreted by control means 15 that generate in turn a command causing the shutdown of compressor 14, thereby maintaining the integrity of exchanger 22. The same would apply if manometer 11 measures a pressure lower than a minimum determined threshold of the pressure of the refrigerant. Other sensors could be arranged to measure the prevailing temperature inside exchanger 24, the temperature of the fluid received at inlet Wi, or the efficiency of the motor of fan 3. Control means 15 may thus be arranged to read (continually or according to one or more predetermined read-periods possibly dedicated to such and such sensor) data supplied by measurement means to develop, based on this data, suitable commands and send them via the control bus to considered components. According to a first embodiment of control means 15, said commands may be generated according to one or multiple cabled logic processes. Control means 15 then comprise one or more combined logic circuits translating one or more cabled logic processes implementing a process for generating a command to activate the first 14 and/or second 24 internal heating means.

As a variation, control means 15 consist of a processing unit (for example a microcontroller) functioning with memory means in which one or more programs are previously recorded, which comprise one or more program instructions that are respectively interpretable or executable by the processing unit and whose execution or interpretation by said processing unit initiates the implementation of one or more command generation processes. Control means 15 may also comprise wired or wireless communication means allowing one to download or update (preferably in a secure manner) a program whose subsequent interpretation or execution of the program instructions by the processing unit will initiate the implementation of a new command generation process.

The cabled programs or logic processes—implemented by control means 15 to generate commands intended particularly for compressor 14 and electric exchanger 24—may also take into consideration one or more operating parameters or one or more setpoints specified by the user of the hybrid heating device. To this end, front panel 1 may comprise a human-machine interface 23. The invention provides as a variant or complement that control means 15 may co-operate with one or more interfaces of remote setpoints (not depicted in FIG. 6) as well as with one or more visual and/or audio restoration interfaces (also not depicted in FIG. 6) for restoring an operating state of the hybrid heating device or also the temperature of the water from the tank thus efficiently heated.

The invention provides that the command generation processes implemented by control means 15 co-operating with acquisition means (measurement and/or safety sensor) and a setpoint interface (for example, interface 23) are established to optimize the power consumption of the hybrid heating device in regard to the setpoint entered by a user via said interface. Control means 15 are thus advantageously parameterized so that the output of device PAC-H is optimized, thereby minimizing the electrical energy consumed regardless of the setpoint entered by the user of said PAC-H.

Any process for generating commands to activate an internal heating means of a hybrid heating device according to the invention implemented by the control means of said device comprises one or several iterations including, respectively, a stage for reading a setpoint and/or a predetermined operating parameter and a stage for controlling the activation of said internal heating means based on said setpoint and/or said parameter.

For example, according to a first operating process, for a heating setpoint of a tank (specifying a desired temperature of the water of said tank—for example a setpoint temperature equal to 27° C.), a first command-generating process consists of triggering the only compressor 14 of the internal heat pump, as soon as the current value of the temperature of the fluid received by fluid input Wi of the hybrid heating device is lower than the setpoint temperature. To do so, hybrid heating device PAC-H comprises measurement means, including a sensor (co-operating with control means 15 for example via the signal bus) to measure the temperature of the fluid received by inlet Wi. A first process may thus comprise, in an iterative manner, a stage for reading the temperature of the fluid measured by said sensor, a stage for comparing said temperature measured by the sensor to the setpoint temperature, and a stage for activating compressor 14 if (or as long as) the measured temperature is less than said setpoint temperature. The frequency of the process iterations may be parameterized by the manufacturer and/or user. This iteration frequency constitutes an operating parameter of the hybrid heating device, a parameter advantageously entered in the internal memory by way of control means 15 or co-operating with said control means.

Such a first process may be advantageously enhanced by conditioning the triggering of compressor 14 if and only if the temperature of the ambient air is greater than a value of the air temperature below which the output of the air-water heat pump becomes insufficient. This temperature value is a preset threshold and possibly parameterizable: said threshold may be advantageously preset to 5° C. The air temperature may be measured by a sensor co-operating with control means 15 via the signal bus. It could be measured, as a variant, by a remote sensor co-operating with control means 15 via wired or wireless communications. As soon as the ambient air temperature becomes less than said threshold, control means 15 automatically trigger a shutdown of compressor 14 (if it is operating) and actuates internal electric exchanger 24. The internal heating means (in other words compressor 14 or electric exchanger 24 according to the ambient air temperature) remains in service as long as the temperature of the water received at the fluid inlet Wi is less than the setpoint temperature. According to a first operating mode, each energy source of internal heating means of hybrid device PAC-H is successively actuated automatically and exclusively by control means 15.

A hybrid heating device according to the invention may also automatically implement other operating modes (or command generation processes) without the user having to make undue efforts, except for [providing] a setpoint of the temperature of the water in the tank.

According to a second operating mode, when internal heating means 14 and 24 are in standby mode (or not actuated), if the temperature of the fluid of the tank received by the fluid inlet Wi is close to the temperature of the setpoint of the user, control means 15 may control the actuation of compressor 14 as soon as this tank temperature decreases by a predetermined threshold (for example a threshold of 3° C.) in relation to said setpoint. Compressor 14 is once again placed in standby mode by control means 15 as soon as the temperature of the tank returns roughly to the setpoint temperature. This mode known as “economy mode” allows one to minimize the electricity consumption of the equipment. The threshold pertaining to the setpoint below which the compressor is not activated corresponds to a predetermined operating parameter of the hybrid heating device.

A third mode of operating (or command generation process) may be automatically implemented by control means 15. Thus, if the temperature of the tank suddenly drops (for example from 4 to 5° C., or even more following a sudden rain shower, falling hail or snow), control means 15 may advantageously simultaneously actuate compressor 14 and electric exchanger 24 to restore a temperature of the tank close to the setpoint temperature as quickly as possible. In this case, the operation of hybrid heating device PAC-H is mixed. An established value for a sudden temperature drop between two successive readings of the temperature of the fluid received at the fluid inlet of the hybrid device, above which the two internal heating means are simultaneously triggered constitutes a predetermined operating parameter of said hybrid heating device. This applies similarly for the measurement frequency of the temperature of said fluid, in other words, the iteration frequency of the process. Each action for controlling the activation of an internal heating means implemented during an iteration of such a process comprises a stage for recording the current value of the temperature measured in the memory means co-operating with the control means. In addition, the stage for controlling an internal heating means simultaneously triggers the first (air-water HP) and second (electric exchanger) internal heating means if the value of the measured temperature of the fluid received at the fluid inlet is less than the one recorded in a previous iteration decreased by said established value for a sudden temperature decrease.

The invention also enables one to implement a fourth operating mode that is particularly innovative and crucial for alerting one to the risk of equipment degradation during a winterization process. This risk is well-known, particularly in regions where the ambient temperatures may be negative during the low seasons of tank usage. The users of conventional HPs in particular are concerned about these periods during which the systems are subject to damage due to the expansion of frozen water. To avoid this inconvenience, it is generally necessary to proceed with the tedious emptying of a large part of the system (use of valve VD described in conjunction with FIG. 2). With a hybrid heating device according to the invention, this type of inconvenience is eliminated. In fact, control means 15 may implement a wintering process, according to which control means 15 automatically control the actuation of internal electric exchanger 24 as soon as the temperature of the fluid received at fluid inlet Wi is roughly equal to a predetermined value of the temperature of the fluid in the tank, below which the integrity of exchanger 22 of the internal HP is jeopardized. This predetermined value may advantageously be equal to 1° C. Thus, based on a “floor” temperature (for example 1° C.), internal electric exchanger 24 is actuated by control means 15 until the temperature of the water circulating in the hybrid heating device reaches a “ceiling” temperature (for example 3° C.). These “floor” and “ceiling” temperatures may be adjusted by the manufacturer or user via setpoint interface 23. They correspond to as many predetermined operating parameters of the hybrid heating device.

Regardless of the command generation process implemented by the control means of a hybrid heating device according to the invention, the predetermined operating parameter or parameters of said hybrid heating device may be advantageously recorded in the memory means co-operating with said control means. As a variant, said parameters may be transmitted to said control means from a setpoint interface (such as interface 23 described in conjunction with FIG. 6 or a remote interface).

Any other mode of programming a hybrid heating device according to the invention could be conceived of as a variant or complement. To do so, it is sufficient to parameterize the control means or enter additional predetermined operating parameters, or even appropriate computer programs, in the memory means co-operating with the processing unit of said control means.

A hybrid heating device according to the invention was described by means of a preferred embodiment comprising two internal heating means: an HP and an electric exchanger. Any other internal heating means could be substituted as a variant for the air-water HP and/or said electric exchanger. Furthermore, an additional internal heating means could be integrated in said hybrid heating device in addition to the two first ones.

1. Hybrid heating device for a fluid contained in a remote tank comprising a fluid inlet for receiving fluid from the tank, a first internal heating means for said fluid, control means co-operating with said first internal heating means and a fluid outlet for returning said heated fluid, the device wherein it also comprises a second internal heating means, said control means being also suited for co-operating with said second internal heating means and for activating alternately or simultaneously the first and second internal heating means according to a setpoint and/or predetermined operating parameter of the device.

2. Hybrid heating device according to claim 1, comprising a housing incorporating the first and second internal heating means as well as the control means.

3. Hybrid heating device according to claim 1, wherein the first internal heating means is an air-water heat pump, whose compressor co-operates with the control means.

4. Hybrid heating device according to claim 1, wherein the second internal heating means is an electric exchanger.

5. Hybrid heating device according to claim 1, wherein the fluid inlet supplies with fluid the first internal heating means, which supplies in turn the second internal heating means, which co-operates with the fluid outlet.

6. Hybrid heating device according to claim 1, wherein the first and second internal heating means co-operate with the control means via a control bus.

7. Hybrid heating device according to claim 1, wherein the setpoint is a temperature setpoint of the fluid of the tank, said device comprising or communicating with a setpoint interface to determine said setpoint, said setpoint interface co-operating with control means of the device.

8. Hybrid heating device according to claim 1, comprising measurement or safety means co-operating with the control means, the latter being suitable for activating alternately or simultaneously the first and second internal heating means according to information supplied by said measurement or safety means in addition to the setpoint and/or the predetermined operating parameter of the device.

9. Hybrid heating device according to claim 8, wherein the measurement or safety means comprise a sensor for measuring the temperature of the fluid received by the fluid inlet.

10. Hybrid heating device according to claim 8, wherein the measurement or safety means comprise a sensor for measuring the ambient air temperature.

11. Hybrid heating device according to claim 1, wherein the control means comprise a processing unit comprising or co-operating with memory means recording the predetermined operating parameter of the device and/or a computer program consisting of one or several program instructions, whose respective interpretations or executions by the processing unit actuate the implementation of command-generating process for activating the first and second internal heating means.

12. Hybrid heating device according to claim 1, wherein the control means comprise a combinatorial logic circuit translating a wired logic implementing a command-generating process for activating the first and/or second internal heating means.

13. Hybrid heating device according to claim 12, wherein the control means comprise or co-operate with memory means for recording the predetermined operating parameter of the device.

14. Process for generating commands for activating an internal heating means of a hybrid heating device comprising a fluid inlet for receiving fluid from the tank, a first internal heating means for said fluid, control means co-operating with said first internal heating means and a fluid outlet for returning said heated fluid, the device wherein it also comprises a second internal heating means, said control means being also suited for co-operating with said second internal heating means and for activating alternately or simultaneously the first and second internal heating means according to a setpoint and/or predetermined operating parameter of the device, said process being implemented by the control means of said hybrid heating device, wherein it comprises one or several iterations comprising respectively a stage for reading a setpoint and/or a predetermined operating parameter and a stage for controlling the activation of an internal heating means according to said setpoint and/or said parameter.

15. Process according to claim 1, wherein the setpoint is a temperature setpoint of the fluid of the tank, said device comprising or communicating with a setpoint interface to determine said setpoint, said setpoint interface co-operating with control means of the device; wherein the measurement or safety means comprise a sensor for measuring the temperature of the fluid received by the fluid inlet; and, wherein the stage for controlling the activation of an internal heating means comprises a stage for reading the value of the temperature of the fluid received by the fluid inlet, a stage for comparing said measured temperature to the setpoint, a stage for triggering the first heating means if said measured temperature is less than said setpoint.

16. Process according to claim 14, wherein the measurement or safety means comprise a sensor for measuring the ambient air temperature, the predetermined operating parameter comprising a predetermined value of the ambient air temperature below which the output of the first heating means is insufficient and for which the stage for controlling activation of an internal heating means comprises a prior stage for reading the value of the measurement of the ambient air temperature, the stage for triggering the first heating means not being executed unless said measured value of the ambient air temperature is greater than said predetermined value, and if not the stage for controlling activation of an internal heating means comprising a stage for actuating the second heating means.

17. Process according to claim 15, wherein the stage for controlling activation of an internal heating means comprises a stage for recording in the memory means the value of the measured temperature of the fluid received by the fluid inlet.

18. Process according to claim 14, wherein the predetermined operating parameter of the device comprises a frequency of iterations, said process comprising a plurality of iterations triggered respectively according to said frequency.

19. Process according to claim 17, wherein the predetermined operating parameter also comprises an established value for a sudden temperature drop, and for which the stage for controlling the activation of an internal heating means simultaneously actuates the first and second internal heating means if the value of the measured temperature of the fluid received by the fluid inlet is less than that recorded during a preceding iteration decreased by said established value for the sudden temperature drop.

20. Process according to claim 14, when the hybrid heating device also conforms with, the measurement or safety means comprise a sensor for measuring the temperature of the fluid received by the fluid inlet, the predetermined operating parameter comprising a predetermined value of the temperature of the fluid from the tank below which the integrity of the first heating means is jeopardized, for which the stage for controlling the activation of an internal heating means actuates the second internal heating means as soon as the temperature of the fluid received at the fluid inlet (Wi) is roughly equal to said predetermined value.

21. Non-transitory computer-readable medium storing computer program comprising one or more program instructions that can be interpreted or executed respectively by the processing unit of a hybrid heating device for a fluid contained in a remote tank comprising a fluid inlet for receiving fluid from the tank, a first internal heating means for said fluid, control means co-operating with said first internal heating means and a fluid outlet for returning said heated fluid, the device wherein it also comprises a second internal heating means, said control means being also suited for co-operating with said second internal heating means and for activating alternately or simultaneously the first and second internal heating means according to a setpoint and/or predetermined operating parameter of the device, and whose interpretation or execution by said unit actuates the implementation of a command-generating process according to claim 14.

22. System comprising a tank containing a fluid to be heated, a remote heating device co-operating with said tank by means of an intake conduit for drawing fluid from the tank and carrying said fluid to a fluid inlet of the heating device and a delivery conduit for carrying said heated fluid from a fluid outlet of the heating device toward the tank, a pump whose action creates a flow of said fluid within the intake conduits and delivery conduits, wherein the heating device is a hybrid heating device according to claim 1.

23. System according to claim 22, wherein the control means comprise a processing unit comprising or co-operating with memory means recording the predetermined operating parameter of the device and/or a computer program consisting of one or several program instructions, whose respective interpretations or executions by the processing unit actuate the implementation of command-generating process for activating the first and second internal heating means, whose processing unit implements a command-generating process for the first and/or second internal heating means of the hybrid heating device, being implemented by the control means of said hybrid heating device, wherein it comprises one or several iterations comprising respectively a stage for reading a setpoint and/or a predetermined operating parameter and a stage for controlling the activation of an internal heating means according to said setpoint and/or said parameter.
